(19) United States
(12) Patent Application Publication
(10) Pub. No.: US 2021/0065220 A1
(43) Pub. Date: Mar. 4, 2021

(54) EXCHANGE PLATFORM ACTIVITY PREDICTION

(71) Applicant: Etsy, Inc., Brooklyn, NY (US)

(72) Inventor: Andrew Sinkov, Brooklyn, NY (US)

(21) Appl. No.: 17/004,787

(22) Filed: Aug. 27, 2020

Related U.S. Application Data
(60) Provisional application No. 62/893,953, filed on Aug. 30, 2019.

(51) Int. Cl. G06Q 30/02; G06Q 10/08; G06Q 50/00; G06Q 10/04; G06N 20/00; G06N 5/04; G06K 9/62

(52) U.S. Cl. CPC G06Q 30/0202; G06Q 10/087; G06Q 10/083; G06Q 50/01; G06K 9/6215; G06N 20/00; G06N 5/04; G06K 9/6217; G06Q 10/04

(57) ABSTRACT

Methods, systems, and apparatus, including computer programs encoded on a computer storage medium, that facilitate forecasting outcomes of items available on an exchange platform and allocating resources to providers of such items to assist the providers achieve the forecasted outcomes. An item on the exchange platform is identified that has received user interactions that are less than a threshold amount. The item's attributes can be obtained, based on which, a uniqueness score can be determined for the given item. The attributes and uniqueness score can be input in an activity forecasting model that outputs the expected user interactions for the given item on the exchange platform. Based on the expected user interactions, the amount of user interactions that the given item receives for a pre-specified time is determined. If this amount satisfies a threshold, a presentation rank of the given item can be increased on the exchange platform.

### CROSS-REFERENCE TO RELATED APPLICATIONS

This application claims the benefit under 35 U.S.C. § 119(e) of U.S. Patent Application No. 62/893,953, entitled “EXCHANGE PLATFORM ACTIVITY PREDICTION,” filed Aug. 30, 2019. The disclosure of the foregoing application is incorporated herein by reference in its entirety for all purposes.

### BACKGROUND

This specification describes systems and methods that facilitate forecasting outcomes of items available on an exchange platform and allocating resources to providers of such items to assist the providers' achieve the forecasted outcomes.

An exchange platform enables exchange of goods, content, and services between end users and providers. Providers can list or provide their goods, contents, and services on the exchange platform, and end users obtain the goods, content, and services from the providers via the exchange platform.

### SUMMARY

In general, one innovative aspect of the subject matter described in this specification can be embodied in methods can include the operations of identifying, by a data processing apparatus and on an exchange platform, a given item that has received user interactions on the exchange platform that is less than a threshold amount of user interactions; obtaining, by the data processing apparatus, attributes of the given item; determining, by the data processing apparatus and based on the attributes of the given item, a uniqueness score indicating a level of uniqueness of the given item relative to the other items that are available through the exchange platform; inputting, by the data processing apparatus, the attributes and the uniqueness score to an activity forecasting model that outputs expected user interactions for the item on the exchange platform, wherein the activity forecasting model is trained using attributes and uniqueness scores of a plurality of items that differ from the given item; obtaining, by the data processing apparatus, an output from the activity forecasting model, the output including a forecasted magnitude of user interactions for the given item over a time period; determining, by the data processing apparatus and based on the forecasted magnitude of user interactions, that the given item will receive at least the threshold amount of user interactions for at least a pre-specified amount of time; and in response to determining that the given item will receive at least the threshold amount of user interactions for at least a pre-specified amount of time, increasing a presentation rank of the product on the exchange platform. These and other embodiments can each optionally include one or more of the following features.

In some implementations, obtaining attributes of the given item includes: obtaining internal signals about the given item on the exchange platform; and obtaining external signals associated with the given item based on content from sources external to the exchange platform.

In some implementations, the internal signals about the given item include: a first number the given item that are offered by the provider on the exchange platform; a second number of users of the exchange platform that viewed the given item; actual outcomes for the given item on the exchange platform; one or more visible features of the materials used to make the item; one or more style classifications of the item; one or more materials used to make the given item; a first amount required to obtain the given item on the exchange platform; a second amount required to deliver the given item to a destination; or a fulfillment time for the given item to arrive at the destination.

In some implementations, obtaining, by the data processing apparatus, internal signals about the given item on the exchange platform includes obtaining one or more materials used to make the given item, wherein obtaining one or more materials used to make the given item includes: obtaining images of the given item on the exchange platform; obtaining description of the given item presented with the image on the exchange platform; and determining materials used to make the product based on an image analysis of the images or the description of the given item.

In some implementations, the sources external to the exchange platform include social media platforms, search platforms, or other content platforms.

In some implementations, obtaining external signals associated with the given item based on content from sources external to the exchange media platform can include obtaining a plurality of content from the sources external to the exchange platform; analyzing the plurality of content to identify one or more content items that include features similar to features of the given item; and classifying each identified content item that includes features similar to features of the product as an external signal.

In some implementations, methods can include in response to determining that the given item will receive at least the threshold amount of user interactions for at least a pre-specified amount of time, generating a visualization of the forecasted magnitude of user interactions for the given item over a time period; and providing the visualization of the forecasted magnitude to the provider.

In some implementations, methods can include: in response to determining that the given item will receive at least the threshold amount of user interactions for at least a pre-specified amount of time, identifying a set of items available on the exchange platform, wherein each item in the set of items has a plurality of attributes that match the attributes of the given item; and increasing presentation ranks of items in the set of items on the exchange platform.

Other embodiments of the above-described aspects can include corresponding systems, devices, apparatus, and computer programs configured to perform the actions of the methods. The computer programs (e.g., instructions) can be encoded on computer storage devices.

Particular embodiments of the subject matter described in this specification can be implemented to realize one or more of the following advantages. For example, the innovations described in this specification enable forecasting user interactions (e.g., views, purchases, searches, etc.) for unique or relatively new items on an exchange platform. Conventional exchange platforms forecast user interactions for a given item based on prior user interactions for the item. However, prior user interactions for an item on the exchange platform may not be a good measure of future user interactions when an item does not have a significant amount of user interactions, as is the case for relatively new items on the exchange platform. For example, when sufficient historical data is not available for a particular item (or type of item), conventional systems may not be able to accurately predict future user interactions for that item. In some situations, conventional exchange platforms may use historical user interactions for similar items to forecast user interactions for a particular item. However, this approach to forecasting user interactions is deficient for unique items, which by their very nature, are different from other items (e.g., in their design, structure, manufacture, or operation). Unlike these conventional exchange platforms that forecast user interactions based on prior user interactions for same item or prior user interactions for other similar items, the exchange platform described in this specification models multiple attributes, uniqueness, and actual user activities for other items to determine a more accurate forecast (as compared with conventional forecasting approaches) of user interactions for item, which includes unique items as well as recently-listed items.

Relatedly, by providing more accurate user interaction forecasts for items (e.g., unique or recently-listed items), the innovations described in this specification enable providers to realize the forecasted amount of user interactions. Conventionally, providers of items on an exchange platform are unaware of the user interactions for their items over a certain period in the future. As a result, providers generally cannot prepare in advance for such user interactions. For example, providers may not maintain an adequate level of resources to accommodate for heightened user interactions for their items, which may result in other providers beginning to provide similar items to satisfy the user interactions. In contrast, the innovations described in this specification provide more accurate expected forecasts of user interactions to providers, which in turn enables providers to realize the forecasted user interactions (e.g., by maintaining adequate amount of inventory of the item).

Relatedly, the innovations described in this specification also allocate resources of the exchange platform to assist providers in satisfying the forecasted user interactions for a particular item. For example, the innovations described in this specification may increase accessibility of a particular item on the platform (e.g., increase rank of product on the exchange platform, increase visibility of the product on the platform). In other words, the techniques discussed throughout this document can adjust the visual arrangement of items in a user interface so as to highlight or relocate items that are predicted to receive at least a threshold amount of user interactions (e.g., within a specified amount of time and/or over a specified amount of time) so that these items are more conveniently located to receive user interactions. As another example, the innovations described in this specification provide detailed forecasts of the period of heightened user interactions and identify proposed values for certain attributes of the item during this period (e.g., proposed inventory during this period) that assists the provider realize the forecasted user interactions for the item.

By assisting providers realize the forecasted user interactions for items—beyond what the providers may have otherwise realized (i.e., without more accurate forecasting and without providing resources, as described in this specification)—the innovations described in this specification not only incentivize existing providers on the platform to continue providing items on the platform, but also encourages new providers to begin providing their items on the exchange platform. Because an exchange platform service provider (i.e., an entity that provides, hosts, operates, and/or maintains the exchange platform) generally receives an amount for each item listed by a provider on the platform, increasing the number of providers increases the number of items provided on the platform, which in turn increases the amount that the exchange platform service provider receives from the listing of these items on the exchange platform.

Relatedly, by increasing the number of items provided on the platform, the innovations described in this specification can also increase the number of users visiting and obtaining items listed on the exchange platform. Because an exchange platform service provider generally receives an amount when an end user obtains an item listed on the exchange platform, an increase in the number of users visiting the exchange platform generally results in an increase in the number of items obtained by end users on the platform. This in turn increases the amount that the exchange platform service provider receives from these items being obtained on the platform.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which an exchange platform facilitates an exchange of good, services, or content between providers and users.

FIG. 2 is a flow diagram of an example process 200 for forecasting user interactions for an item and allocating platform resources to the provider of the item based on the forecasted user interactions.

FIG. 3 is a block diagram that illustrates an example of the operations executed by the components of the exchange platform.

FIG. 4 is a block diagram of computing devices that may be used to implement the systems and methods described in this document

Like reference numbers and designations in the various drawings indicate like elements.

### DETAILED DESCRIPTION

This disclosure relates to computer implemented methods and systems that facilitate forecasting outcomes of items available on an exchange platform and allocating resources to providers of such items to assist the providers' achieve the forecasted outcomes.

Providers may provide items (e.g., goods, services, and content) on an exchange platform that users of the exchange platform (e.g., registered members of the platform or guests of the platform) can obtain. When a provider first provides an item or provides a unique item (e.g., items which may be different in design, manufacture, operation, or function, from other items listed on the exchange platform or other items readily available through mainstream sources) on an exchange platform, such items initially may not garner the amount of user interactions (e.g., purchases, views, or searches for the items) on the exchange platform that is observed by other more mainstream items. However, even if an item initially does not garner significant user interactions, the user interactions for the item may change in the future. In some instances, the user interactions for an item may change significantly unbeknownst to the item's provider, who may not have adequately prepared to satisfy the user interactions.

This specification describes systems and methods that forecasts the user interactions for items on an exchange platform and allocates resources to providers to realize the forecasted interactions.

As described in detail below, the systems and methods described in this specification forecast user interactions for a particular item listed on an exchange platform by obtaining attributes of the item, determining the uniqueness of the item relative to other items, and using the attributes and the uniqueness of the item to determine the forecasted user interactions for the item. As used in this specification, an attribute is a property or feature of the item that identifies the item, describes the item (e.g., describes the item's design, operation, structure, etc.), or discusses the item (e.g., on social media platforms). Attributes of an item can include internal signals and external signals. As used in this document, internal signals are attributes that are identified from data stored about the item on the exchange platform (e.g., images of the item, description of the item presented with the item's listing) as well as other data about the item that may not be presented along with the listing for the given item but may nevertheless maintained on the exchange platform (e.g., data that may be maintained only by the provider or the exchange platform, such as purchase history, fulfillment information, etc.). External signals are attributes about the item that are obtained (e.g., identified or extracted) from data received from sources external to the exchange platforms, including social media platforms, content platforms, or other platforms. Examples of external signals include, among others, the number of references of an item (e.g., likes, shares, searches for the items) on the external sources and user, third party interest (e.g., celebrities, industry authorities) in the item, or images of the item in publications (e.g., media web sites, celebrity social media posts).

The systems and methods described in this specification obtain internal and external signals for a given item by processing and extracting information from data stored on the exchange platform as well as from sources external to the platform. Additional details regarding obtaining internal and external signals are described below.

The systems and methods described in this specification generate a uniqueness score based on the obtained attributes. As used in this specification, uniqueness score specifies the uniqueness of the item relative to other items (which may be available on the platform and/or on other sources). The systems and methods described in this specification model historical data about other items provided on the platform to determine a uniqueness score for an item. Based on this modeling (which is described further below), the systems and methods described in this specification assign a weighted score to each attribute and then aggregates these weighted scores to generate the uniqueness score.

The system and methods described in this specification determine a user interactions forecast for the item based on the attributes of the item and its uniqueness score. As described further in this specification, the attributes and the generated uniqueness score for the item are input to an activity forecast model, which outputs the user interactions forecast for the item. The activity forecast model is trained using attributes, uniqueness scores, and actual user interactions of other items. Based on the input attributes and uniqueness score of the item, the activity forecast model outputs the user interactions forecast for the item.

If the user interactions forecast for a particular item satisfies (e.g., meets or exceeds) a user interactions threshold, the systems and methods described in this specification allocate exchange platform resources to providers of the item to assist the providers satisfy the forecasted user interactions for the item. This includes increasing the accessibility of item on the exchange platform, which, as further described in this specification, can be accomplished by adjusting the exchange platform's search algorithms to elevate the presentation of the item's listing in user searches for similar items (e.g., increase rank of product on the exchange platform, increase visibility of the product on the platform). The system and methods described in this specification can also provide visualizations (e.g., graphs) of the period(s) of heightened forecasted user interactions along with proposed attributes (e.g., proposed quantity of the item) that are likely to realize the forecasted user interactions during or after such periods.

These and additional features are described in more detail below.

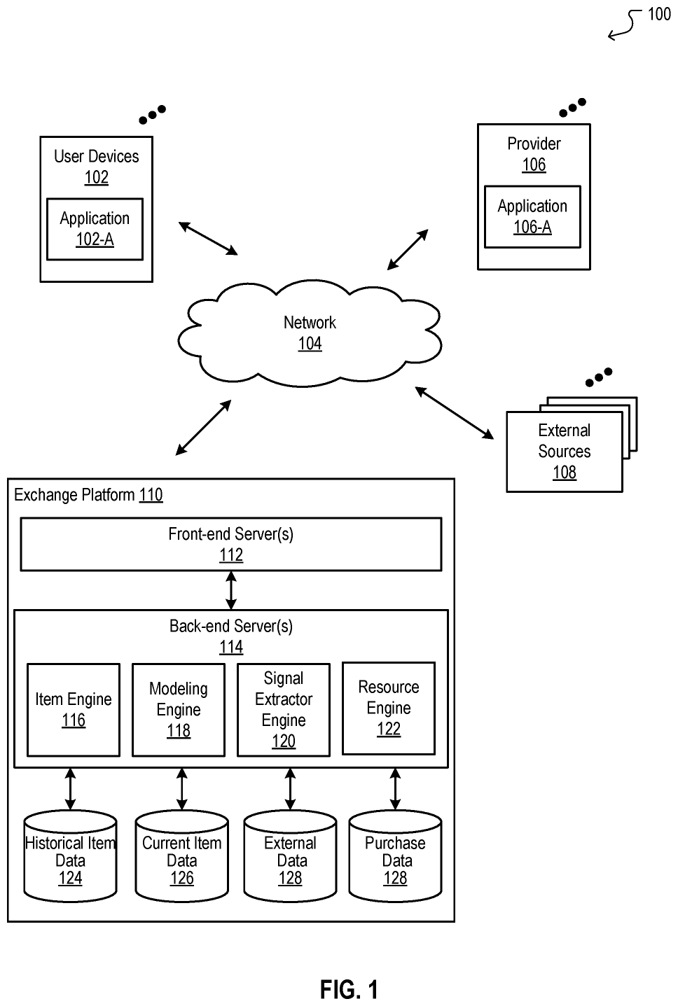

FIG. 1 is a block diagram of an example environment 100 in which an exchange platform facilitates an exchange of good, services, or content between providers and users. The example environment 100 includes a network 104, such as a local area network (LAN), a wide area network (WAN), the Internet, or a combination thereof. The network 104 connects one or more user devices 102, one or more provider devices 106, an exchange platform 110, and one or more external sources 108.

User device 102 and provider device 106 are electronic devices that are capable of requesting and receiving content and resources over the network 104. Examples of such devices include personal computers, mobile communication devices, digital assistant devices, and other devices that can send and receive data over the network 108.

The exchange platform 110 is a computing platform that can be operated and maintained by an exchange service provider. The exchange platform 110 enables providers to list their items on the exchange platform 110 and enables users to obtain the item listed on the exchange platform 110. As depicted in the block diagram of FIG. 1, the exchange platform 110 is depicted as a single block with various sub-blocks. However, while the exchange platform 110 could be a single device or single set of devices, this specification contemplates that the content provider could also be a group of devices, or even multiple different systems that communicate with each other to enable the exchange of goods, services, and/or content on the platform. Exchange platform 110 could also be a provider of items or may be an entity different from the provider, as shown in FIG. 1.

A provider uses an application 106-A executing on a provider device 106 to communicate with the exchange platform 110 to, for example, create or manage listings of items of provider on the exchange platform 110 and/or perform other appropriate tasks related to the exchange platform 110 (e.g., transfer an amount to the provider based on items obtained by users). The application 106-A can transmit data to, and receive data from, the exchange platform 110 over the network 104. The application 106-A can be implemented as a native application developed for a particular platform or a particular device, web browser that provides a web interface, or another appropriate type of application. The application 106-A can present and detect user interactions (e.g., user's touch, mouse clicks, etc.) with various interfaces that enable, for example, the provider to create and manage listings of the provider's items on the exchange platform 110.

Users of a user device 102 can use an application 102-A to communicate with the exchange platform 110 to, for example, view listings of items, search for items, obtain items, and/or perform other appropriate tasks related to the exchange platform 110. The application 102-A can transmit data to, and receive data from, the exchange platform 110 over the network 104. The application 102-A can be implemented as a native application developed for a particular platform or a particular device, web browser that provides a web interface, or another appropriate type of application. The application 102-A can present and detect user interactions (e.g., user's touch, mouse clicks, etc.) with various interfaces that enable, for example, the user to view listings of items, search for items, obtain items, and/or perform other appropriate tasks related to the exchange platform 110.

The exchange platform 110 includes one or more front-end servers 112 and one or more back-end servers 114. The front-end servers 112 can transmit data to, and receive data from, user devices 102 and provider devices 106, over the network 104. For example, the front-end servers 112 can provide to, applications 102-A and 106-A executing on user devices 102 and provider devices 106, respectively, interfaces and/or data for presentation with the interfaces. The front-end servers 112 can also receive data specifying user interactions with the interfaces provided by the front-end servers 112 to user devices 102 and provider devices 106. The front-end servers 112 can update the interfaces, provide new interfaces, and/or update the data presented by the interfaces presented in applications 102-A and 106-A, respectively, based on user/provider interactions with user devices 102 and provider devices 106.

The front-end servers 112 can also communicate with the back-end servers 114. For example, the front-end servers 112 can identify data to be processed by the back-end servers 114, e.g., data specifying information necessary to create listings requested by a provider 106, data specifying the quantity of a given item that a user of user device 102 is requesting to obtain. The front-end servers 112 can also receive, from the back-end servers 114, data for a particular user of a user device 102 or a provider device 106, and transmit the data to the appropriate user device 102 or provider device 106 over the network 104.

The back-end servers 114 include a product engine, a modeling engine, a signal extractor engine 120, and a resource engine 122. As used in this specification, the term engine refers to hardware, e.g., one or more data processing apparatuses, that execute software that performs a set of tasks. Although FIG. 1 depicts these four engines, the operations of these engines as described in this specification may be performed, wholly or in part, by one or more other engines. In other words, some implementations may include more than the four engines depicted in the FIG. 1 to perform the operations described in this specification. Alternatively, some implementations may include fewer engines to perform the operations described in this specification. Further still, even if an implementation includes the same four engines depicted in FIG. 1, the operations performed by one of these engines, as described in this specification, may be performed by one or more of the other engines.

The item engine 116 manages the creation and modification of listings of items, as requested by a provider via application 106-A on a provider device 106. The item engine 116 can receive from the front end-servers 112, data specifying a description of an item for a listing initiated by a provider. Based on this description, the item engine 116 can create the listing within the exchange platform 110. The description of the item can include, for example, a name for the item, a brief description of the item, a quantity of the item, an amount required to obtain the particular item, an amount required to deliver the item to a destination, a fulfillment time for the item to arrive at the destination, and one or more images of the item. The item engine 116 can use some or all of this information to create a listing for the item on the exchange platform 110. The item engine 116 can store the data for the listing, including the received information, in a current item data storage device 126. The item data storage device 126 can include one or more databases (or other appropriate data storage structures) stored in one or more non-transitory data storage media (e.g., hard drive(s), flash memory, etc.).

The item engine 116 can also receive from the front end-servers 112, data specifying attributes of an item listing that a provider 106 may want to modify. For example, provider 106, through application 106-A, may seek to modify one or more attributes of the provider's item listed on the exchange platform 110. The modified attributes are communicated from the application 106-A to front-end server 112 over network 104. The item engine 116 in turn receives from the front end-servers 112, data specifying attributes of the item listing that the provider 106 wants to modify. The attributes to be modified may include, for example, the quantity of available items and the amount required to obtain the item. The item engine 116 can use the data about the modified attributes to modify the listing for the item on the exchange platform 110. The item engine 116 can then use the modified attributes to update the item's attributes stored in the current item data storage device 126.

The item engine 116 can also receive from the front-end servers 112, data specifying a user's request to view one or more listings of items, search for items, and/or obtain an item. If a user searches for an item or a type of item on the exchange platform, the user's query is received by front-end servers 112, which in turn sends the query to the item engine 116. The item engine 116 uses the data specified in the query to identify the appropriate listings stored in the current item data storage device 126. The item engine 116 communicates the identified listing(s) to the front-end servers 112, which in turn provides a particular listing or a summary of listings for presentation on the application 102-A. If a summary of listings is presented to the user in application 102-A, the user can select a link for one listing from among the summary of listings. The user's selection of the link is received by the front-end server 112, which interprets the user's selection as a request for data about the particular listing. The front-end servers 112 request item engine 116 to provide data about the particular listing, which the item engine 116 obtains from the current item data storage device 126. The item engine 116 responds to the front-end servers 112 with the obtained data, which is then provided by the front-end servers 112 to the application 102-A in the form of a page showing a listing for the item.

When a user views a listing for an item on the exchange platform displayed on the application 102-A, the user may decide to obtain the item. The user may select a button (or other appropriate user interface element) on the interface presented on application 102-A, which may result in the front-end servers 112 providing a different user interface to the user where the user can enter pertinent details (e.g., quantity of the item, the destination address, payment information) to begin the fulfillment process for purchasing the item. Upon submitting this information (e.g., by clicking a submit button on the user interface), the details entered by the user along with attributes of the item that the user wants are received by the front-end servers 112 and passed to the item engine 116. The item engine 116 evaluates whether the received data is valid (e.g., whether the quantity of the item requested by the user is the same or less than the available quantity of the item, whether the shipping address is correct, whether the payment information is correct).

If the data received from the user is invalid, the item engine 116 sends a message to the front-end servers indicating that the request is denied along with a reason explaining why the request was denied (e.g., credit card was not approved or invalid shipping address). The front-end servers 112 can provide a new user interface for presentation in application 102-A, in which the user is notified that the user's request was unsuccessful.

If, however, the data received from the user is valid, the item engine 116 processes the payment using the received payment information and sends a message, including the received user data, to the appropriate provider to begin the fulfillment process. The item engine 116 may store purchase information about the item (e.g., identifier of the user purchasing the item, the quantity of the item purchased, the amount provided for the item, the date of purchase) in a purchase data storage device 128. The purchase data storage device 128 can include one or more databases (or other appropriate data storage structures) stored in one or more non-transitory data storage media (e.g., hard drive(s), flash memory, etc.). Subsequently, the item engine 116 can send a message to the front-end servers 112, indicating that fulfillment processing has begun. Upon receiving this message from the item engine 116, the front-end servers 112 can provide a new user interface for presentation in application 102-A, in which the user is notified that the user's request was successful and that the order processing has begun.

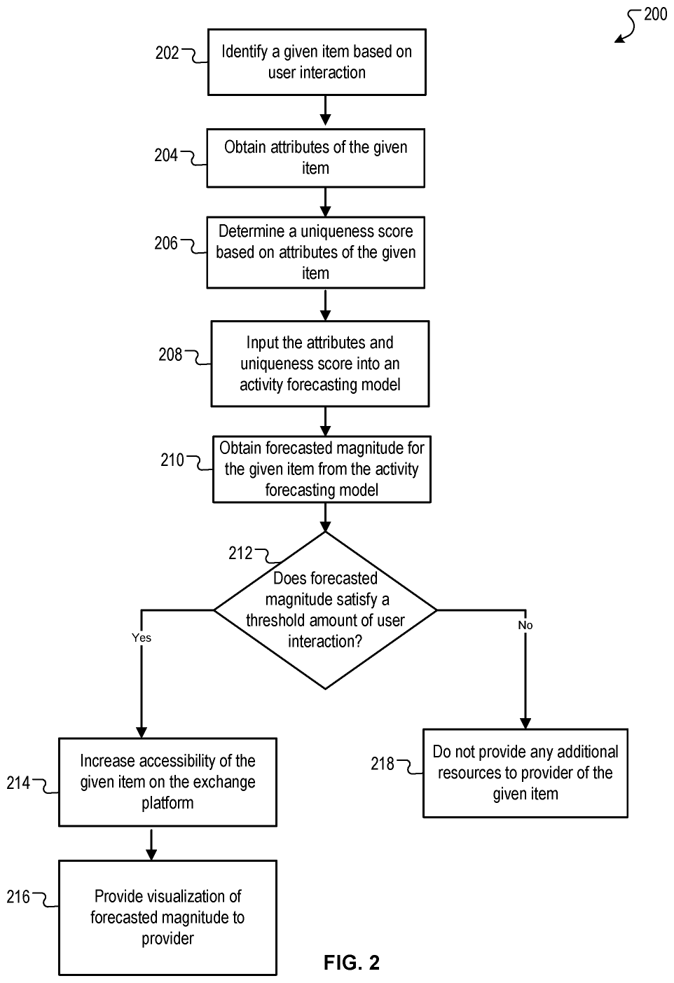

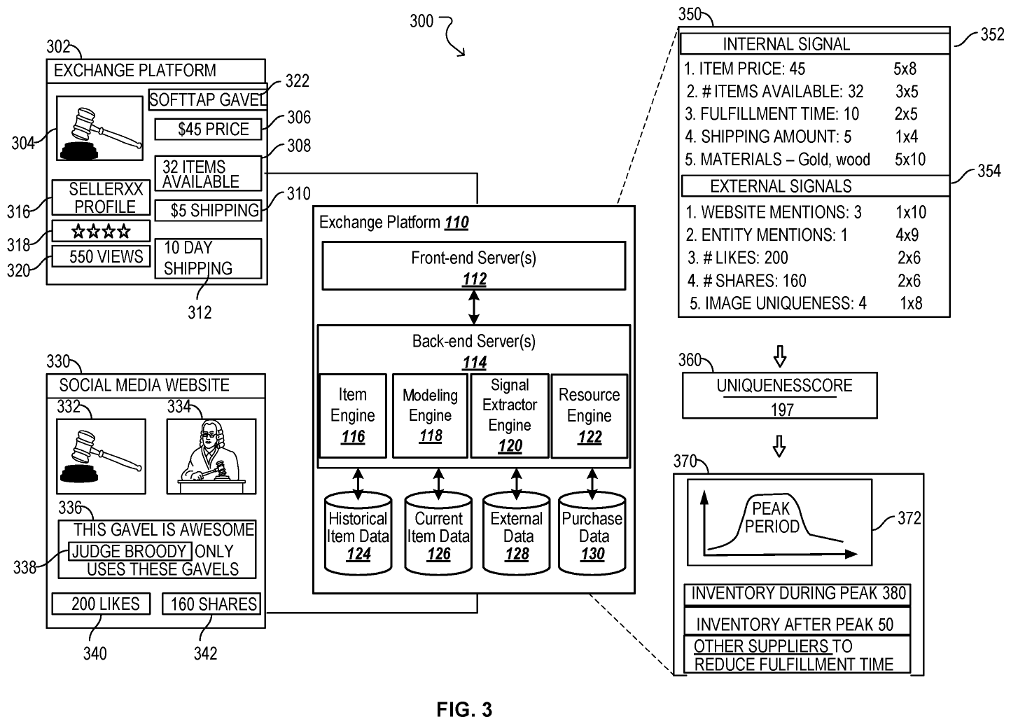

The operation of the other components of the example environment 100 are described with reference to FIGS. 2 and 3 below.

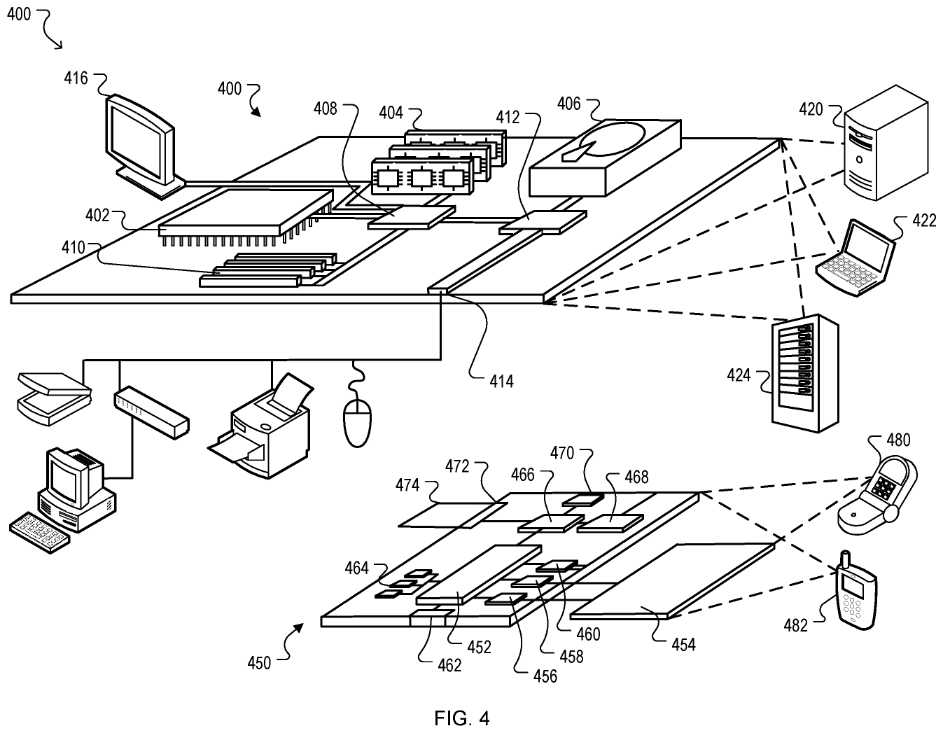

FIG. 2 is a flow diagram of an example process 200 for forecasting user interactions for an item and allocating platform resources to the provider of the item based on the forecasted user interactions. Operations of the process 200 are described below as being performed by the components of the exchange platform 110. The operations of the process 200 are described below for purposes of illustration only. The operations of the process 200 can be performed by any appropriate device or system, e.g., any appropriate data processing apparatus (also referred to as “computing device” with reference to FIG. 4), include a device or system that may not be part of the exchange platform (e.g., a proxy server through which all traffic to and from the exchange platform flows). Operations of the process 200 can also be implemented as instructions stored on a non-transitory computer readable medium. Execution of the instructions cause one or more data processing apparatus to perform operations of the process 200.

The exchange platform 110 identifies a given item on the exchange platform based on user interactions for that item (at 202). In some implementations, the modeling engine 118 identifies a given item based on whether the user interactions for the given item on the exchange platform 110 is less than a threshold amount of user interactions. As used in this specification, a threshold amount of user interactions can be a value specified by the exchange platform service provider. Alternatively, the modeling engine 118 can determine the threshold amount of user interactions based on the user interactions for one or more items (other than the given item) on the exchange platform 110. As one example, the modeling engine 118 can identify the items in the same category as the given item and then generate an average of the user interactions (e.g., item purchases) across the items in this category. The threshold amount of user interactions may also be determined in other ways, such as for example, by using the median of the user interactions for a particular category of items or by using the mean user interactions for a subset of the items (e.g., items with the highest user interactions in a particular category) listed on the platform.

If the user interactions for the given item satisfies (e.g., meets or exceeds) the threshold amount of user interactions, the modeling engine 118 skips further processing. On the other hand, if the user interactions for the given item does not satisfy the threshold amount of user interactions, the modeling engine 118 identifies the given item as requiring further processing, as described below with respect to operations 204 to 218.

The exchange platform 110 obtains attributes of the given item (at 204). In some implementations, if the modeling engine 118 determines that the user interactions of the given item does not satisfy the threshold amount of user interactions, the modeling engine 118 sends a message to the signal extractor engine 120 to perform further processing with respect to the given item. Upon receiving this message, the signal extractor engine 120 obtains attributes of the given item, which may include internal signals as well as external signals.

The signal extractor engine 118 obtains internal signals from information about the given item stored by the exchange platform 110 (e.g., in the current item data storage device 126). In some instances, the information stored by the exchange platform 110 for a given item is already in the form of internal signals. This may include signals such as price of the item, number of items available, the shipping price of the item, and the provider's ratings, which may also be data fields that are provided with the item's listing. This may also include, for example, signals such as visible features of the materials used to make the item and one or more style classifications of the item. In other instances, the information stored on the exchange platform 110 for a given item may be further analyzed to extract signals. For example, the signal extractor engine 120 may include an image recognition engine that recognizes objects in the images of the given item presented on the exchange platform 110 by the provider. The image recognition may further include a neural network or other machine learning system that has been trained using a set of training images to identify from the images of the given item, the types of materials used in the manufacture of the item. Thus, using the image recognition engine, the signal extractor 120 identifies the materials in the manufacture of the given item, which is another type of an internal signal. An example of obtaining internal signals is described with reference to FIG. 3.

In addition to obtaining internal signals for the given item, the signal extractor engine 120 also obtains external signals about the given item based on information from external sources 108, which are external to the exchange platform 110. External sources 108 can include social media platforms, search platforms, or other content platforms. The signal extractor engine 118 can use information about the given item stored by the exchange platform 110 to identify relevant information from the external sources 108. In some implementations, the signal extractor engine 120 can use the images of the given item to find similar images of the item and associated content on external sources 108. In some implementations, the signal extractor engine 120 can also use description of the given item on the exchange platform 110 (e.g., title of the given item, purchase amount, shipping amount, provider name) as well as information extracted from the information about the given item stored on the exchange platform 110 (e.g., the materials used in manufacturing the product, as described in the preceding paragraph) to find the given item or similar items and the associated content available from the external sources 108. In response, the signal extractor engine 120 receives content from the external sources 108 over network 104. The signal extractor 120 stores this content from the external sources 108 in the external data storage device 128. The external data storage device 128 can include one or more databases (or other appropriate data storage structures) stored in one or more non-transitory data storage media (e.g., hard drive(s), flash memory, etc.).

The signal extractor engine 120 can obtain, from the external storage device 128, the content received from the external sources 108 and identify one or more external signals from this content. External signals include, among other signals, the number of times the given item has been referenced on external sources 108, user perception of the given item e.g., which may be determined by assigning a score based on the number of “likes” and “shares” of content describing or discussing the given item on the external sources 108. External signals can also include image uniqueness, which may be a score assigned to the given item based on a search (on the external sources 108) for the image of the given item or similar looking items. For example, if the search of the external sources identifies the given item or similar looking items, the signal extractor engine may assign a lower image uniqueness score than if the search did not identify (or identified fewer) images on the external sources 108 that are the same or similar to the given item. An example of obtaining external signals is described with reference to FIG. 3.

The exchange platform 110 determines, based on the attributes of the given item obtained in operation 204, a uniqueness score indicating a level of uniqueness of the given item relative to the other items that are available through the exchange platform 110 (at 206). In some implementations, after the signal extractor 120 obtains the attributes of the given item, the signal extractor 120 sends a message to the modeling engine 118 to generate a uniqueness score. In response, the modeling engine 118 inputs the attributes (obtained at operation 204) into a uniqueness scoring model. The uniqueness scoring model provides the uniqueness score of the given item based on the input attributes and uniqueness score. This model is generated using the attributes of other items (which may be obtained from the historical item data storage device 124), including items that the exchange platform service provider has identified as unique items and for which the user interactions exceeds the threshold amount of user interactions (as described above). For example, the uniqueness scoring model can be a mathematical model that represents the relationships between uniqueness of various item attributes, such that the uniqueness scoring model can output a uniqueness score given an input of item attributes. The uniqueness scoring model can be generated using unsupervised learning, or other machine learning techniques. The historical item data storage device 124 can include one or more databases (or other appropriate data storage structures) stored in one or more non-transitory data storage media (e.g., hard drive(s), flash memory, etc.). The uniqueness scoring model can be implemented, for example, as any one of the following: SIFT, Gist, Cross domain matching, and support vector machine/pattern matching.

In some implementations, the uniqueness scoring model assigns scores and weights to values of each input attribute for the given item. The uniqueness scoring model generates a weighted score for each attribute (e.g., by multiplying the weight with the score for each attribute) and then aggregates (e.g., by adding) the weighted scores to obtain a uniqueness score. An example of the computation of the uniqueness score is described with reference to FIG. 3.

The modeling engine 118 inputs the attributes of the given item and its uniqueness score into an activity forecasting model (at 208). The activity forecasting model forecasts the magnitude of user interactions for a given item. The activity forecasting model is generated using, for example, the attributes and uniqueness scores of other items on the exchange platform 110 (which are stored in the historical item data storage device 124) as well as the other items' actual magnitude of user interactions (which may also be stored in historical item data storage device 124 and/or the purchase data storage device 130). The activity forecasting model can also utilize additional information such as, for example, user-provided interest information, inference from historical actions, more complex estimation of activity from inverse reinforcement learning, transfer learning, etc.

Using this information, the activity forecasting model models the forecasted magnitude of user interactions for the given item (at 210). The forecasted magnitude of user interactions can be represented in many ways. For example, the forecasted magnitude of user interactions can forecast the total forecasted user interactions over a certain period (e.g., an aggregate (or sum) of user interactions over the certain period). As another example, the forecasted magnitude can be the highest (or maximum) forecasted user interactions during a certain period. As another example, the forecasted magnitude can be the average of the forecasted user interactions during a certain period. As another example, the forecasted magnitude can be a distribution of forecasts of user interactions over a certain period. The modeling engine 118 can configure the activity forecasting model to output the forecasted magnitude in any of the above-described (or any other appropriate) formats specified by the exchange platform service provider or the modeling engine 118.

The modeling engine 118 determines whether the forecasted magnitude satisfies (e.g., meets or exceeds) the threshold amount of user interactions (at 212). If the forecasted magnitude satisfies the threshold amount of user interactions, the modeling engine 118 sends a message to the resource engine 122 to provide additional resources to the provider of the given item, which can include performing operations 214 and/or 216 described below. On the other hand, if the forecasted magnitude does not satisfy the threshold amount of user interactions, the modeling engine 118 does not message resource engine 122 to provide any additional resources to the provider of the given item.

In response to receiving the message from the modeling engine 118 to provide additional resources (as described in the preceding paragraph), the resource engine 122 increases the accessibility of the given item on the exchange platform 110 (at 214). The resource engine 122 can increase the accessibility of the given item on the exchange platform 110 in many ways. In some implementations, the resource engine 122 can adjust the search algorithms for the exchange platform 110 to increase the presentation rank of the given item's listing in listings of items provided by the exchange platform 110 in response to user searches for similar items. For example, the resource engine can increase the presentation rank of the given item's listing by altering, e.g., rankings output by the search algorithms of the platform to, for example, display the given item's listing in the first ten results provided in response to a user query for similar items. In other words, the resource engine 122 can adjust the visual arrangement of items in a user interface so as to highlight or relocate items that are predicted to receive at least a threshold amount of user interaction (e.g., within a specified amount of time and/or over a specified amount of time) so that these items are more conveniently located to receive user interactions. Alternatively, or additionally, the resource engine 122 can increase the accessibility of the given item by sending notifications that include a listing of the given item to members of the exchange platform 110 (e.g., as emails to these members) who may have purchased similar items or items in the same or similar category as the given item.

In addition, the resource engine 122 can also identify a set of items available on the exchange platform 110 that have multiple attributes that match or are among the attributes of the given item. In some implementations, the resource engine 122 can use the attributes of the given item to identify other items on the exchange platform 110 that have all the same attributes as the given item or a threshold number of attributes that are the same as the given item. For these identified items, which may be considered as similar to the given item, the resource engine 122 can increase accessibility (e.g., elevate the presentation rank) of these items on the exchange platform 110, in the same manner as described above.

In addition to increasing the accessibility of the item on the exchange platform 110, the resource engine 122 can also provide a visualization of the forecasted magnitude to assist the provider realize the forecasted magnitude (at 216). In some implementations, the resource engine 122 can provide a graph showing a distribution of the forecasted magnitude of user interactions over a certain period. The resource engine 122 obtains this distribution from the modeling engine 118. In some implementations, the resource engine 120 messages the modeling engine 118 to provide a distribution of the forecasted magnitude for particular time intervals during a certain period. In response, the modeling engine 118 inputs the attributes of the given item and its uniqueness score to the activity forecasting model (as described above). The modeling engine 118 also specifies (1) the output format of the activity forecasting model (as described above), which in this case is a distribution format and (2) the period over which to provide this distribution. The modeling engine 118 obtains the distribution of values from activity forecasting model and sends this information to the resource engine 122. The resource engine 122 then uses this distribution of data to generate a graph that assists the provider to visualize the forecast of the user interactions during a certain period. The resource engine 122 provides the data to generate this graph to the front end server 112, which then presents an interface displaying the graph, in the application 106-A of the provider device 106. In some situations, the provider device 106 can also be provided a list of items that are expected to achieve the threshold amount of user interactions, thereby allowing the provider to more quickly distinguish those items from other items offered by the provider, which will more quickly direct the provider to items of interest.

The resource engine 122 can also use the distribution that it receives from the modeling engine 118, to provide information in textual format that can provide precise guidance to providers to realize the forecasted magnitude. For example, in addition to showing graph of the forecasted user interactions over a certain period, the resource engine 122 can also provide textual data that precisely identifies the quantity of the given item needed to meet the forecasted magnitude. In this example (and as further described with reference FIG. 3), if based on the distribution, the resource engine 122 determines that the provider is estimated to sell 300 units of the given item per month for three months followed by 50 units in the fourth month and 20 units in the fifth month, the resource engine 122 may also notify the provider 106 (e.g., in an email message to the provider, or in a user interface of application 106-A where provider manages the listing of the given item) of the inventory of the given item needed to meet the expected purchases during the first three months and during the last two months.

FIG. 3 is a block diagram that illustrates an example of the operations executed by the components of the exchange platform 110, which are described with reference to FIG. 2.

The exchange platform 110 may perform operation 202 to identify an item with a name “Softtap Gavel” (322) based on the user interactions for that item.

The signal extractor engine 120 obtains attributes of this item as described with reference to FIG. 2. The signal extractor engine 120 obtains internal signals from data stored within the platform, including the data stored and displayed on the item's listing page, which is shown as display 302. Specifically, display 302 shows a listing of the Softtap Gavel (322) on the exchange platform's website. Display 302 includes the name of the item, Softtap Gavel (302), and additional details about the item, including an image of the Softtap Gavel (304), the purchase price (306), the number of items available (308), the shipping amount (310), and the fulfillment time (312). Display 302 also includes information about the provider of the item, including a link to the provider's profile (316), the provider's rating represented as a number of stars (318), and the number of views of the item on the platform (320).

The signal extractor engine 120 can obtain the internal signals directly from this information (i.e., from information stored in fields 304-322). For example, the signal extractor 120 identifies fields on the Softtap Gavel's listing as internal signals, such as the item price, number of items available, fulfillment time, and shipping amount, which are shown at 352. The signal extractor engine 120 can also obtain internal signals by analyzing data stored in the fields 304-322. For example, the signal extractor engine 120 uses the image recognition engine, which is described with reference to FIG. 2, to analyze the objects in the image of the Softtap Gavel (304) and determine the materials used to manufacture the product. In this example, the signal extractor engine 120 determines that the Softtap Gavel is made from wood and gold (as shown at 352) and related signals such as color, texture, pattern, and similarity to a known item style.

The signal extractor engine 120 also obtains external signals from external sources, such as the social media platform, which is separate and distinct from the exchange platform (e.g., hosted in a different domain and/or operated by a different entity than the exchange platform), shown in FIG. 3. In this example, the signal extractor engine 120 searches for the image (304) of the Softtap Gavel on social media website (330) and identifies a web page shown as 330. The signal extractor engine 120 parses the content on the page 330 to obtain external signals, such as current trends for the particular item. For example, the signal extractor engine 120 obtains the “200 Likes” (340) and “160 Shares” (342) and maps these to the external signals “#Like” and “#Shares,” which are shown at 354. As another example, the signal extractor engine 120 identifies trends in usage of the given item, for example, by identifying entities (such as the text “Judge Broody” (338)) that have referenced, discussed, or used the given item. In some implementations, the signal extractor engine 120 can assign more weight to high profile entities (e.g., celebrities, artists, etc.) that are associated with the given item.

The modeling engine 120 inputs the internal and external signals to a uniqueness scoring model, as described with reference to FIG. 2, to determine a uniqueness score. The uniqueness scoring model assigns scores and weights to each signal. As shown in display 352, for each signal, the uniqueness scoring model assigns a score (on a scale from 1 to 5) and a weight (on a scale from 1 to 10). For example, for the “item price” internal signal, the uniqueness model assigns a score of 5 and a weight of 8 (as represented by 5×8). The score specifies the relative value of the attribute for this item among values of this attribute for other items. The weight specifies the relative importance of this attribute among other attributes in assessing uniqueness of an item. In this example, the materials attribute (shown at 352) has the highest weight of 10 because the uniqueness scoring model may have determined, based on data about other items, that there is a strong correlation between unique items and the types of materials used. Similarly, the materials attribute has the highest score of 5 because the uniqueness scoring model may have determined, based on data about other items, that gold and wood combined are higher quality materials than other materials. In this way, the uniqueness scoring model assigns scores and weights to each of the internal and external signals. Additional attributes that are evaluated in assessing uniqueness of the item include number of searches for the item and the number of clicks for that item on the exchange platform.

After the scores and weights have been assigned to each signal, the modeling engine 120 determines a weighted score for each signal by multiplying the score and weight for the signal (as described above). For example, the weighted score for the signal Item Price is five multiplied by eight, or 40. The modeling engine 120 generates the uniqueness score by, in one embodiment, summing up the weighted scores for each signal to obtain a uniqueness score of 197 (i.e., 5×8+3×5+2×5+1×4+5×10+1×10+4×9+2×6+2×6+1×8), which is shown at 360.

Displays 350 and 360 may be available for display to the exchange service platform provider. These displays may also be presented to the provider, e.g., as a user interface in the application 106-A from which the provider accesses the exchange platform 110, or as content that is sent in an e-mail message to the provider. Alternatively, the displays 350 and 360 may not be displayed to any provider. In either case, the data for displays 350 and 360 may be stored in a data storage device (e.g., memory, hard drive), which can be accessed by the resource engine 122 to provide data for displays, such as the display shown at 370.

As described above with reference to FIG. 2, the modeling engine 120 inputs the uniqueness score and the attributes of the item into an activity forecasting model, which outputs the user interactions forecast for the item over a specified period. This information is used by the resource engine 122 to generate data for display, which the resource engine 122 provides to the front end servers 112 to generate a display that is then provided to the provider, e.g., in an interface displayed on application 106-A.

As shown in display 370, the display 370 includes a graph that shows a distribution of user interactions for a given period (as described above with reference to FIG. 2). The graph also identifies a “peak period,” which specifies the portion of the charted period during which the user interactions is expected to be the highest. The display 370 also includes additional information, such as textual information that further assists the provider to prepare for and realize the forecasted user interactions, such as the inventory that the provider 106 needs to maintain during the peak and non-peak periods. Display 370 also provides a link (“Other Supplier to Reduce Fulfillment Time”) that the provider may select. Upon selection of this link, the provider may be presented with another interface (in application 106-A) on which the provider is shown a list of suppliers who provide the materials that the provider uses to manufacture the item. In this example, the resource engine 122 may generate this list of suppliers by searching for all suppliers (within or external to the exchange platform) who supply the materials that are used to manufacture the item (as determined by the signal extractor engine and as described above). In this way, the resource engine 122 may provide appropriate information based on the attributes of the item to assist the provider realize the forecasted user interactions.

FIG. 4 is a block diagram of computing devices 400, 450 that may be used to implement the systems and methods described in this document, either as a client or as a server or plurality of servers, or in cloud computing environments. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component such as an application server, or that includes a front end component such as a client computer having a graphical user interface or a Web browser through which a user can interact with an implementation of the systems and techniques described here, or any combination of such back end, middleware, or front end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

As used in this specification, the term “module” is intended to include, but is not limited to, one or more computers configured to execute one or more software programs that include program code that causes a processing unit(s)/device(s) of the computer to execute one or more functions. The term “computer” is intended to include any data processing or computing devices/systems, such as a desktop computer, a laptop computer, a mainframe computer, a personal digital assistant, a server, a handheld device, a smartphone, a tablet computer, an electronic reader, or any other electronic device able to process data.

A number of embodiments have been described. Nevertheless, it will be understood that various modifications may be made without departing from the spirit and scope of the invention. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

1. A computer implemented method, comprising:
identifying, by a data processing apparatus and on an exchange platform, a given item that has received user interactions on the exchange platform that is less than a threshold amount of user interactions;
obtaining, by the data processing apparatus, attributes of the given item;
determining, by the data processing apparatus and based on the attributes of the given item, a uniqueness score indicating a level of uniqueness of the given item relative to the other items that are available through the exchange platform;
inputting, by the data processing apparatus, the attributes and the uniqueness score to an activity forecasting model that outputs expected user interactions for the item on the exchange platform, wherein the activity forecasting model is trained using attributes and uniqueness scores of a plurality of items that differ from the given item;
obtaining, by the data processing apparatus, an output from the activity forecasting model, the output including a forecasted magnitude of user interactions for the given item over a time period;
determining, by the data processing apparatus and based on the forecasted magnitude of user interactions, that the given item will receive at least the threshold amount of user interactions for at least a pre-specified amount of time; and
in response to determining that the given item will receive at least the threshold amount of user interactions for at least a pre-specified amount of time, increasing a presentation rank of the given item on the exchange platform.

2. The computer implemented method of claim 1, wherein obtaining attributes of the given item includes:
obtaining internal signals about the given item on the exchange platform; and
obtaining external signals associated with the given item based on content from sources external to the exchange platform.

3. The computer implemented method of claim 2, wherein the internal signals about the given item include:
a first number the given item that are offered by the provider on the exchange platform;
a second number of users of the exchange platform that viewed the given item;
actual outcomes for the given item on the exchange platform;
one or more visible features of the materials used to make the item;
one or more style classifications of the item;
one or more materials used to make the given item;
a first amount required to obtain the given item on the exchange platform;
a second amount required to deliver the given item to a destination; or
a fulfillment time for the given item to arrive at the destination.

4. The computer implemented method of claim 2, wherein obtaining, by the data processing apparatus, internal signals about the given item on the exchange platform includes obtaining one or more materials used to make the given item, wherein obtaining one or more materials used to make the given item includes:
obtaining images of the given item on the exchange platform;
obtaining description of the given item presented with the image on the exchange platform; and
determining materials used to make the product based on an image analysis of the images or the description of the given item.

5. The computer implemented method of claim 2, wherein the sources external to the exchange platform include social media platforms, search platforms, or other content platforms.

6. The computer implemented method of claim 2, wherein obtaining external signals associated with the given item based on content from sources external to the exchange media platform, includes:
obtaining a plurality of content from the sources external to the exchange platform;
analyzing the plurality of content to identify one or more content items that include features similar to features of the given item; and
classifying each identified content item that includes features similar to features of the product as an external signal.

7. The computer implemented method of claim 1, further comprising:
in response to determining that the given item will receive at least the threshold amount of user interactions for at least a pre-specified amount of time, generating a visualization of the forecasted magnitude of user interactions for the given item over a time period; and
providing the visualization of the forecasted magnitude to the provider.

8. The computer implemented method of claim 1, further comprising:
in response to determining that the given item will receive at least the threshold amount of user interactions for at least a pre-specified amount of time, identifying a set of items available on the exchange platform, wherein each item in the set of items has a plurality of attributes that match the attributes of the given item; and
increasing presentation ranks of items in the set of items on the exchange platform.

9. A system, comprising:
one or more memory devices storing instructions; and
one or more data processing apparatus that are configured to interact with the one or more memory devices, and upon execution of the instructions, perform operations including:
identifying, by a data processing apparatus and on an exchange platform, a given item that has received user interactions on the exchange platform that is less than a threshold amount of user interactions;
obtaining, by the data processing apparatus, attributes of the given item;
determining, by the data processing apparatus and based on the attributes of the given item, a uniqueness score indicating a level of uniqueness of the given item relative to the other items that are available through the exchange platform;
inputting, by the data processing apparatus, the attributes and the uniqueness score to an activity forecasting model that outputs expected user interactions for the item on the exchange platform, wherein the activity forecasting model is trained using attributes and uniqueness scores of a plurality of items that differ from the given item;
obtaining, by the data processing apparatus, an output from the activity forecasting model, the output including a forecasted magnitude of user interactions for the given item over a time period;
determining, by the data processing apparatus and based on the forecasted magnitude of user interactions, that the given item will receive at least the threshold amount of user interactions for at least a pre-specified amount of time; and
in response to determining that the given item will receive at least the threshold amount of user interactions for at least a pre-specified amount of time, increasing a presentation rank of the given item on the exchange platform.

10. The system of claim 9, wherein obtaining attributes of the given item includes:
obtaining internal signals about the given item on the exchange platform; and
obtaining external signals associated with the given item based on content from sources external to the exchange platform.

11. The system of claim 10, wherein the internal signals about the given item include:
a first number the given item that are offered by the provider on the exchange platform;
a second number of users of the exchange platform that viewed the given item;
actual outcomes for the given item on the exchange platform;
one or more visible features of the materials used to make the item;
one or more style classifications of the item;
one or more materials used to make the given item;
a first amount required to obtain the given item on the exchange platform;
a second amount required to deliver the given item to a destination; or
a fulfillment time for the given item to arrive at the destination.

12. The system of claim 10, wherein obtaining, by the data processing apparatus, internal signals about the given item on the exchange platform includes obtaining one or more materials used to make the given item, wherein obtaining one or more materials used to make the given item includes:
obtaining images of the given item on the exchange platform;
obtaining description of the given item presented with the image on the exchange platform; and
determining materials used to make the product based on an image analysis of the images or the description of the given item.

13. The system of claim 10, wherein the sources external to the exchange platform include social media platforms, search platforms, or other content platforms.

14. The system of claim 10, wherein obtaining external signals associated with the given item based on content from sources external to the exchange media platform, includes:
obtaining a plurality of content from the sources external to the exchange platform;
analyzing the plurality of content to identify one or more content items that include features similar to features of the given item; and
classifying each identified content item that includes features similar to features of the product as an external signal.

15. The system of claim 9, wherein the one or more data processing apparatus are configured to perform operations further comprising:
in response to determining that the given item will receive at least the threshold amount of user interactions for at least a pre-specified amount of time, generating a visualization of the forecasted magnitude of user interactions for the given item over a time period; and
providing the visualization of the forecasted magnitude to the provider.

16. The system of claim 9, wherein the one or more data processing apparatus are configured to perform operations further comprising:
in response to determining that the given item will receive at least the threshold amount of user interactions for at least a pre-specified amount of time, identifying a set of items available on the exchange platform, wherein each item in the set of items has a plurality of attributes that match the attributes of the given item; and
increasing presentation ranks of items in the set of items on the exchange platform.

17. A non-transitory computer readable medium storing instructions that, when executed by one or more data processing apparatus, cause the one or more data processing apparatus to perform operations comprising:
identifying, by a data processing apparatus and on an exchange platform, a given item that has received user interactions on the exchange platform that is less than a threshold amount of user interactions;
obtaining, by the data processing apparatus, attributes of the given item;
determining, by the data processing apparatus and based on the attributes of the given item, a uniqueness score indicating a level of uniqueness of the given item relative to the other items that are available through the exchange platform;
inputting, by the data processing apparatus, the attributes and the uniqueness score to an activity forecasting model that outputs expected user interactions for the item on the exchange platform, wherein the activity forecasting model is trained using attributes and uniqueness scores of a plurality of items that differ from the given item;
obtaining, by the data processing apparatus, an output from the activity forecasting model, the output including a forecasted magnitude of user interactions for the given item over a time period;
determining, by the data processing apparatus and based on the forecasted magnitude of user interactions, that the given item will receive at least the threshold amount of user interactions for at least a pre-specified amount of time; and
in response to determining that the given item will receive at least the threshold amount of user interactions for at least a pre-specified amount of time, increasing a presentation rank of the given item on the exchange platform.

18. The non-transitory computer readable medium of claim 17, wherein obtaining attributes of the given item includes:
obtaining internal signals about the given item on the exchange platform; and
obtaining external signals associated with the given item based on content from sources external to the exchange platform.

19. The non-transitory computer readable medium of claim 18, wherein the internal signals about the given item include:
a first number the given item that are offered by the provider on the exchange platform;
a second number of users of the exchange platform that viewed the given item;
actual outcomes for the given item on the exchange platform;
one or more visible features of the materials used to make the item;
one or more style classifications of the item;
one or more materials used to make the given item;
a first amount required to obtain the given item on the exchange platform;
a second amount required to deliver the given item to a destination; or
a fulfillment time for the given item to arrive at the destination.

20. The non-transitory computer readable medium of claim 18, wherein obtaining, by the data processing apparatus, internal signals about the given item on the exchange platform includes obtaining one or more materials used to make the given item, wherein obtaining one or more materials used to make the given item includes:
obtaining images of the given item on the exchange platform;
obtaining description of the given item presented with the image on the exchange platform; and
determining materials used to make the product based on an image analysis of the images or the description of the given item.

21. The non-transitory computer readable medium of claim 18, wherein the sources external to the exchange platform include social media platforms, search platforms, or other content platforms.

22. The non-transitory computer readable medium of claim 18, wherein obtaining external signals associated with the given item based on content from sources external to the exchange media platform, includes:
obtaining a plurality of content from the sources external to the exchange platform;
analyzing the plurality of content to identify one or more content items that include features similar to features of the given item; and
classifying each identified content item that includes features similar to features of the product as an external signal.

23. The non-transitory computer readable medium of claim 17, wherein the instructions cause the one or more data processing apparatus to perform operations comprising:
in response to determining that the given item will receive at least the threshold amount of user interactions for at least a pre-specified amount of time, generating a visualization of the forecasted magnitude of user interactions for the given item over a time period; and
providing the visualization of the forecasted magnitude to the provider.

24. The non-transitory computer readable medium of claim 17, wherein the instructions cause the one or more data processing apparatus to perform operations comprising:
in response to determining that the given item will receive at least the threshold amount of user interactions for at least a pre-specified amount of time, identifying a set of items available on the exchange platform, wherein each item in the set of items has a plurality of attributes that match the attributes of the given item; and
increasing presentation ranks of items in the set of items on the exchange platform.
